(19) United States
(12) Patent Application Publication
(10) Pub. No.: US 2025/0301214 A1
(43) Pub. Date: Sep. 25, 2025

(54) INTELLIGENT EDGE POWER MANAGEMENT

(71) Applicant: Johnson Controls Tyco IP Holdings LLP, Milwaukee, WI (US)

(72) Inventors: Christopher R. IRVINE, Craigavon (GB); William T. CALVERT, Belfast (GB); Terence NEILL, Lisburn (GB)

(21) Appl. No.: 18/862,472

(22) PCT Filed: Apr. 28, 2023
(86) PCT No.: PCT/US2023/066388

§ 371 Date: Nov. 1, 2024

Related U.S. Application Data
(60) Provisional application No. 63/338,372, filed on May 4, 2022.

(51) Int. Cl. H04N 23/65; G02B 27/00; G06V 10/70; G06V 10/82; G06V 10/94; G06V 10/96; G06V 10/98; G06V 20/52; H04N 7/18; H04N 23/62; H04N 23/667

(52) U.S. Cl. CPC H04N 23/651; G06V 10/82; G06V 10/87; G06V 10/94; G06V 10/96; G06V 10/993; G06V 20/52; H04N 23/62; H04N 23/667; G02B 27/0006; H04N 7/18

(57) ABSTRACT

Example implementations include a method, apparatus, and computer-readable medium for power management of an edge device using one or more of: “Situational Switching Neural Networks,” “Motion Detection Management of Analytics,” “Reduced Frames-Per-Second (FPS) and Resolution Power Saving,” “Smart Video Streaming,” “Power Saving Peripherals Management,” “Smart Power Saving Camera Lens Defog,” and “Power Management Dashboard.”

### CROSS REFERENCE TO RELATED APPLICATION(S)

This application claims the benefit of U.S. Provisional Application Ser. No. 63/338,372, entitled “INTELLIGENT EDGE POWER MANAGEMENT FOR VIDEO SURVEILLANCE” and filed on May 4, 2022, which is expressly incorporated by reference herein in the entirety.

### FIELD

The present disclosure relates generally to security systems, and in particular, to power management in edge devices.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An example aspect includes a method comprising determining, by a device, a power saving criteria associated with an amount of power consumed by the device for performing analytics. The method further includes selecting, by the device, from among two or more neural networks configured for performing the analytics under different power saving criteria, a neural network that is configured for performing the analytics under the power saving criteria. Additionally, the method further includes using the neural network to perform the analytics by the device.

Another example aspect includes an apparatus comprising a memory and a processor communicatively coupled with the memory. The processor is configured to determine, by a device, a power saving criteria associated with an amount of power consumed by the device for performing analytics. The processor is further configured to select, by the device, from among two or more neural networks configured for performing the analytics under different power saving criteria, a neural network that is configured for performing the analytics under the power saving criteria. Additionally, the processor further configured to use the neural network to perform the analytics by the device.

Another example aspect includes an apparatus comprising means for determining, at a device, a power saving criteria associated with an amount of power consumed by the device for performing analytics. The apparatus further includes means for selecting, at the device, from among two or more neural networks configured for performing the analytics under different power saving criteria, a neural network that is configured for performing the analytics under the power saving criteria. Additionally, the apparatus further includes means for using the neural network to perform the analytics by the device.

Another example aspect includes a computer-readable medium having instructions stored thereon, the instructions executable by a processor to determine, by a device, a power saving criteria associated with an amount of power consumed by the device for performing analytics. The instructions are further executable to select, by the device, from among two or more neural networks configured for performing the analytics under different power saving criteria, a neural network that is configured for performing the analytics under the power saving criteria. Additionally, the instructions are further executable to use the neural network to perform the analytics by the device.

An example aspect includes a method comprising determining, by a camera, whether image or video analytics performed at the camera has returned a detection result within a threshold period of time. The method further includes placing, by the camera, the image or video analytics in a sleep mode responsive to an absence of any detection results returned by the image or video analytics.

Another example aspect includes an apparatus comprising a memory and a processor communicatively coupled with the memory. The processor is configured to determine, by a camera, whether image or video analytics performed at the camera has returned a detection result within a threshold period of time. The processor is further configured to place, by the camera, the image or video analytics in a sleep mode responsive to an absence of any detection results returned by the image or video analytics.

Another example aspect includes an apparatus comprising means for determining, at a camera, whether image or video analytics performed at the camera has returned a detection result within a threshold period of time. The apparatus further includes means for placing, at the camera, the image or video analytics in a sleep mode responsive to an absence of any detection results returned by the image or video analytics.

Another example aspect includes a computer-readable medium having instructions stored thereon, the instructions executable by a processor to determine, by a camera, whether image or video analytics performed at the camera has returned a detection result within a threshold period of time. The instructions are further executable to place, by the camera, the image or video analytics in a sleep mode responsive to an absence of any detection results returned by the image or video analytics.

An example aspect includes a method comprising receiving, by a camera, via a user interface on the camera, a power saving criteria associated with an amount of power consumed by the camera for performing image or video analytics. The method further includes performing, by the camera, image or video analytics on image or video data having a frames per second “FPS” value or an image resolution value configured to meet the power saving criteria.

Another example aspect includes an apparatus comprising a memory and a processor communicatively coupled with the memory. The processor is configured to receive, by a camera, via a user interface on the camera, a power saving criteria associated with an amount of power consumed by the camera for performing image or video analytics. The processor is further configured to perform, by the camera, image or video analytics on image or video data having a frames per second “FPS” value or an image resolution value configured to meet the power saving criteria.

Another example aspect includes an apparatus comprising means for receiving, at a camera, via a user interface on the camera, a power saving criteria associated with an amount of power consumed by the camera for performing image or video analytics. The apparatus further includes means for performing, at the camera, image or video analytics on image or video data having a frames per second “FPS” value or an image resolution value configured to meet the power saving criteria.

Another example aspect includes a computer-readable medium having instructions stored thereon, the instructions executable by a processor to receive, by a camera, via a user interface on the camera, a power saving criteria associated with an amount of power consumed by the camera for performing image or video analytics. The instructions are further executable to perform, by the camera, image or video analytics on image or video data having a frames per second “FPS” value or an image resolution value configured to meet the power saving criteria.

An example aspect includes a method comprising determining, by a camera, whether all streams in a video pipeline of the camera are being used to stream video data output by the camera. The method further includes closing, by the camera, one or more streams and one or more associated buffers responsive to determining that the one or more streams are not being used.

Another example aspect includes an apparatus comprising a memory and a processor communicatively coupled with the memory. The processor is configured to determine, by a camera, whether all streams in a video pipeline of the camera are being used to stream video data output by the camera. The processor is further configured to close, by the camera, one or more streams and one or more associated buffers responsive to determining that the one or more streams are not being used.

Another example aspect includes an apparatus comprising means for determining, at a camera, whether all streams in a video pipeline of the camera are being used to stream video data output by the camera. The apparatus further includes means for closing, at the camera, one or more streams and one or more associated buffers responsive to determining that the one or more streams are not being used.

Another example aspect includes a computer-readable medium having instructions stored thereon, the instructions executable by a processor to determine, by a camera, whether all streams in a video pipeline of the camera are being used to stream video data output by the camera. The instructions are further executable to close, by the camera, one or more streams and one or more associated buffers responsive to determining that the one or more streams are not being used.

An example aspect includes a method comprising determining, by a camera, whether a peripheral connection of the camera is connected to any peripheral devices. The method further includes placing, by the camera, the peripheral connection in a low power state responsive to determining that the peripheral connection is not connected to any peripheral devices.

Another example aspect includes an apparatus comprising a memory and a processor communicatively coupled with the memory. The processor is configured to determine, by a camera, whether a peripheral connection of the camera is connected to any peripheral devices. The processor is further configured to place, by the camera, the peripheral connection in a low power state responsive to determining that the peripheral connection is not connected to any peripheral devices.

Another example aspect includes an apparatus comprising means for determining, at a camera, whether a peripheral connection of the camera is connected to any peripheral devices. The apparatus further includes means for placing, at the camera, the peripheral connection in a low power state responsive to determining that the peripheral connection is not connected to any peripheral devices.

Another example aspect includes a computer-readable medium having instructions stored thereon, the instructions executable by a processor to determine, by a camera, whether a peripheral connection of the camera is connected to any peripheral devices. The instructions are further executable to place, by the camera, the peripheral connection in a low power state responsive to determining that the peripheral connection is not connected to any peripheral devices.

An example aspect includes a method comprising determining, by a camera, whether a defogging of a lens of the camera is required. The method further includes controlling, by the camera, a heater configured to defog the lens of the camera responsive to determining that the defogging of the lens of the camera is required.

Another example aspect includes an apparatus comprising a memory and a processor communicatively coupled with the memory. The processor is configured to determine, by a camera, whether a defogging of a lens of the camera is required. The processor is further configured to control, by the camera, a heater configured to defog the lens of the camera responsive to determining that the defogging of the lens of the camera is required.

Another example aspect includes an apparatus comprising means for determining, at a camera, whether a defogging of a lens of the camera is required. The apparatus further includes means for controlling, at the camera, a heater configured to defog the lens of the camera responsive to determining that the defogging of the lens of the camera is required.

Another example aspect includes a computer-readable medium having instructions stored thereon, the instructions executable by a processor to determine, by a camera, whether a defogging of a lens of the camera is required. The instructions are further executable to control, by the camera, a heater configured to defog the lens of the camera responsive to determining that the defogging of the lens of the camera is required.

An example aspect includes a method comprising displaying, by a camera, a power management dashboard on a user interface of the camera, wherein the power management dashboard includes one or more power management indicators and one or more user input receivers, wherein the one or more power management indicators include a central processing unit “CPU” usage indicator and a power consumption indicator configured, respectively, to display real-time measurements of a CPU usage and a power consumption of the camera, and wherein the one or more user input receivers are configured for receiving user input for selecting a power saving mode for the camera.

Another example aspect includes an apparatus comprising a memory and a processor communicatively coupled with the memory. The processor is configured to display, by a camera, a power management dashboard on a user interface of the camera, wherein the power management dashboard includes one or more power management indicators and one or more user input receivers, wherein the one or more power management indicators include a central processing unit “CPU” usage indicator and a power consumption indicator configured, respectively, to display real-time measurements of a CPU usage and a power consumption of the camera, and wherein the one or more user input receivers are configured for receiving user input for selecting a power saving mode for the camera.

Another example aspect includes an apparatus comprising means for displaying, at a camera, a power management dashboard on a user interface of the camera, wherein the power management dashboard includes one or more power management indicators and one or more user input receivers, wherein the one or more power management indicators include a central processing unit “CPU” usage indicator and a power consumption indicator configured, respectively, to display real-time measurements of a CPU usage and a power consumption of the camera, and wherein the one or more user input receivers are configured for receiving user input for selecting a power saving mode for the camera.

Another example aspect includes a computer-readable medium having instructions stored thereon, the instructions executable by a processor to display, by a camera, a power management dashboard on a user interface of the camera, wherein the power management dashboard includes one or more power management indicators and one or more user input receivers, wherein the one or more power management indicators include a central processing unit “CPU” usage indicator and a power consumption indicator configured, respectively, to display real-time measurements of a CPU usage and a power consumption of the camera, and wherein the one or more user input receivers are configured for receiving user input for selecting a power saving mode for the camera.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a schematic diagram of an example video surveillance system implementing power management for one or more cameras, according to some aspects;

FIG. 2 is an example power management dashboard on a camera in the example video surveillance system of FIG. 1, according to some aspects;

FIG. 3 is a block diagram of an example computing device which may implement all or a portion of a camera, a building management station, or any other device, system, or component in FIG. 1, according to some aspects;

FIG. 4 is a flow diagram of a first example method for power management, according to some aspects;

FIG. 5 is a flow diagram of a second example method for power management, according to some aspects;

FIG. 6 is a flow diagram of a third example method for power management, according to some aspects;

FIG. 7 is a flow diagram of a fourth example method for power management, according to some aspects; and

FIG. 8 is a flow diagram of a fifth example method for power management, according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components may be shown in block diagram form in order to avoid obscuring such concepts.

Some present aspects reduce the overall power consumption of edge devices in a network such as a wired and/or wireless network. For example, some present aspects reduce the overall power consumption of video surveillance cameras by controlling one or more features of the cameras at the network edge, that is, on a chip on the cameras. In some aspects, a video surveillance camera may control the power consumption of the processes that are executed on the camera during run-time operation, while maintaining accurate and reliable security surveillance. In some example implementations, the present aspects may be used to provide increased power consumption efficiency for networks of edge devices (such as, but not limited to, closed-circuit television (CCTV) camera networks), enabling energy saving targets to be met in an unmanned and intelligent solution. In some cases, there may be a large number of cameras that use a building power supply, and due to the scale of power consumption (e.g., thousands of cameras connected to the power supply network of an airport, shopping center, etc.), the power consumed by the cameras becomes an issue. Accordingly, even a small power saving on each camera would amount to significant power savings over time.

The present aspects may alternatively or additionally be implemented for surveillance systems that include battery-powered cameras (e.g., body-worn cameras) to conserve power and increase the battery life of the cameras.

Turning now to the figures, example aspects are depicted with reference to one or more components described herein, where components in dashed lines may be optional.

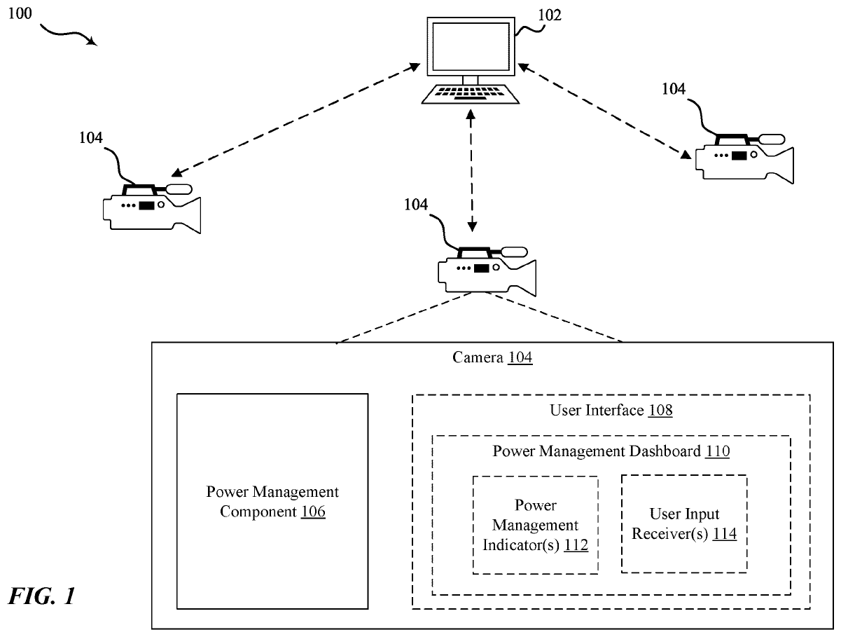

Referring to FIG. 1, a video surveillance system 100 includes a building management station 102 in communication with one or more video surveillance cameras 104 configured to monitor an area, e.g., in a premises, a shopping center, a parking lot, etc. The cameras 104 may include a power management component 106 configured to implement one or more of the power management aspects described below with reference to, e.g., “Situational Switching Neural Networks,” “Motion Detection Management of Analytics,” “Reduced Frames-Per-Second (FPS) and Resolution Power Saving,” “Smart Video Streaming,” “Power Saving Peripherals Management,” “Smart Power Saving Camera Lens Defog,” and “Power Management Dashboard.” In some non-limiting example aspects, one or more of the cameras 104 may provide one or more of the power management aspects described below via one or more user input receivers 114 and/or one or more power management indicators 112 on a power management dashboard 110 on a user interface 108 of the cameras 104. The various power management aspects described below may be implemented either standalone or in conjunction with one other.

Although some present aspects are described herein with reference to the video surveillance system 100 including the cameras 104, the present aspects are not so limited, and are applicable for power management in any network that includes edge devices that perform analytics.

### Situational Switching Neural Networks

Some present aspects deploy situational neural networks during run-time of the cameras 104, allowing the camera firmware to switch dynamically between different neural networks depending on the environment, use case, etc. In some aspects, the neural networks may be used for intelligent visual object classification at the edge, that is, on the surveillance cameras 104. In some aspects, the neural networks are trained taking color information into account. However, in some aspects, surveillance in low light environments may use infrared imaging which returns information in a black and white format, requiring less information per pixel as compared to a color image. Accordingly, the present aspects improve the efficiency of neural network processing by generating and training neural network models for low light levels, thus reducing CPU usage and power consumption during low light operation as compared to normal light operation.

In an aspect, for example, the camera 104 may have a red-green-blue (RGB) sensor as well as an infra-red (IR) sensor. In one non-limiting aspect, for example, the RGB sensor may be used during day-time operation and produces 256 bits of information for each color, while the IR sensor produces black and white information during night-time operation and therefore generates less data as compared to the RGB sensor. Accordingly, two separate neural networks may be installed on the camera 104, one for use during day-time operation and another one for use during night-time operation. In some non-limiting aspects, the neural networks may be pre-trained prior to installation on the camera 104. However, in some alternative or additional aspects, the neural networks may be at least partially trained or re-trained after being installed on the camera 104.

Some example implementations may use more than two neural networks which are configured for use during more than two situations. For example, in an aspect, different neural networks may be used for different types of image (e.g., portrait versus scene), different complexity levels of the captured scene (e.g., indoor versus outdoor, static (e.g., a backyard) versus dynamic (e.g., a moving crowd), etc.), different numbers and/or types of objects detected in the scene, different scene depths (e.g., a room versus a hallway), different climates (e.g., foggy versus bright), different camera power saving modes, different remaining battery levels of the camera 104, etc.

For example, in an aspect, two or more different neural networks of varied sizes may be developed and trained for use under different desired power consumption levels. For example, a first neural network may be configured and trained for normal power consumption use, and a second neural network may also be developed with lower power consumption as compared to the first neural network. In order to reduce power consumption, the second neural network may be configured with fewer nodes and/or edges as compared to the first neural network. This gives the end user the option for a tradeoff between power consumption and accuracy, so that the user may choose a desired level of compromise of accuracy in return for lower power consumption. In one non-limiting example implementation, when the camera 104 is battery-powered, the camera 104 may switch from using the first neural network to using the second neural network upon determining that the battery level of the camera 104 has dropped below a low battery threshold value, e.g., below 25%. The camera 104 may switch back to using the first neural network upon determining that the battery of the camera 104 has been recharged to a high battery threshold value, e.g., above 80%.

In another example aspect, two or more different neural networks of varied sizes may be developed and trained for use under different scene complexity levels. For example, a first neural network may be configured and trained for monitoring a crowded scene (e.g., monitoring a shopping center during busy shopping hours). A second neural network with lower power consumption and fewer nodes and/or edges as compared to the first neural network may also be developed to monitor a less crowded scene (e.g., monitoring a shopping center when most stores are closed).

### Motion Detection Management of Analytics

In some aspects, the video analytics processes of the camera 104 may be power-intense. In order to conserve power, the camera 104 may determine whether the video analytics processes have returned a result within a specified period of time, e.g., whether a face, object, or event is detected by the video analytics processes within a specified period of time. In these aspects, if the video analytics processes have not returned a result within the specified period of time, the camera 104 may place the video analytics processes into a sleep mode to conserve power.

Thereafter, an external process may monitor for detecting motion in the vicinity of the camera 104. If motion is detected in the vicinity of the camera 104, the camera 104 restarts the video analytics processes. Accordingly, the video analytics processes only run for frames that the camera 104 deems necessary, thus saving CPU usage and power consumption.

In some non-limiting example implementations, the camera 104 may include a motion detector. Alternatively, the camera 104 may receive the output of a motion detector installed in a vicinity of the camera 104 and having a field of view that is at least partially overlapping with the field of view of the camera 104. Either way, the camera 104 may use the output of the motion detector to determine whether to restart the video analytics processes of the camera 104.

In an alternative or additional aspect, the camera 104 may execute the video analytics processes intermittently/periodically. For example, in an aspect, the camera 104 may put the video analytics processes into a sleep mode for a specified OFF time (e.g., 5 minutes). After the specified OFF time has elapsed, the camera 104 may restart the video analytics processes and run the video analytics processes for a short ON time (e.g., 30 seconds). If the video analytics processes have not returned a result within the short ON time, the camera 104 puts the video analytics processes back into the sleep mode for another cycle of OFF time, and the ON/OFF cycle repeats.

### Reduced FPS and Resolution Power Saving

In some cases, a camera may be configured with a fixed FPS and/or resolution that is optimized for the video analytics processes of the camera 104. However, some present aspects provide an option on the camera 104 to give the user the capability to reduce the FPS and/or resolution at which the video analytics processes of the camera 104 are running. Such reduction of FPS and/or resolution lessens the power consumption by reducing the information and memory bandwidth that is required to process an image within a timeframe.

In one example aspect, the camera 104 provides an option to the user to save power by reducing the FPS of video data used in the video analytics processes, in return for less responsiveness. In some non-limiting aspects, the camera 104 may provide this option via one or more user input receivers 114 and/or one or more power management indicators 112 on a power management dashboard 110 on a user interface 108 of the camera 104.

In an alternative or additional aspect, the camera 104 provides an option to the user to save power by reducing the resolution of video data used in the video analytics processes, in return for less accuracy. The camera 104 may provide this option via one or more user input receivers 114 and/or one or more power management indicators 112 on the power management dashboard 110 on the user interface 108 of the camera 104.

For example, some video analytics processes are configured to provide a certain detection certainty threshold or confidence level in detecting objects, faces, events, etc. In one non-limiting aspect, for example, video analytics processes that provide object classification may indicate with 70% certainty/confidence that an object is a car or a person, so as to trigger an alarm. However, in some present aspects, a user may choose to save power by reducing the resolution to the video analytics processes, which reduces the detection certainty/confidence threshold (e.g., from 70% to 60%).

In an alternative or additional aspect, for example, the camera 104 may allow the user to set a power saving mode, and the camera 104 is configured to realize the user-selected power saving mode by changing the FPS and/or resolution at which the video analytics processes of the camera 104 are running. Once the user selects a power saving mode, the camera 104 may indicate to the user how the selected/desired power saving mode affects/changes the confidence level, resolution, and/or FPS at which the video analytics processes of the camera 104 are running. The camera 104 may also give a warning to the user if the power saving mode selected by the user causes a confidence level, resolution, or FPS that is below a corresponding minimum recommended level.

### Smart Video Streaming

In some cases, the camera 104 may have the capability to produce a video pipeline that includes multiple video streams, in which case multiple memory buffers may be used to allow the multiple video streams to flow through the video pipeline. Sometimes not every video stream is being used. For example, the camera 104 may not be connected, not all of the camera streams may be polled by a client, some video streams may not be streamed to a destination, etc. In these cases, some of the memory buffers used for the multiple video streams of the camera 104 are redundant.

However, in some present aspects, the camera 104 may optimize video streaming by implementing an intelligent monitoring of the video pipeline of the camera 104 and/or providing user controls (e.g., via one or more user input receivers 114 and/or one or more power management indicators 112 on the power management dashboard 110 on the user interface 108 of the camera 104) to monitor and regulate the video pipeline of the camera 104.

In one non-limiting aspect, for example, the camera firmware shuts down the redundant resources by closing the memory buffers and individual streams that are not being used. Accordingly, these aspects achieve power savings by using only the required memory buffers.

In a further non-limiting aspect, if there is no client or destination streaming imaging from the camera 104, the entire video pipeline of the camera 104 may be shut down/closed until a client or destination polls the camera 104 for a video stream.

### Power Saving Peripherals Management

Some video surveillance systems or devices may include multiple peripheral connections/slots/ports configured to receive one or more peripheral devices. For example, in some aspects, the camera 104 may include one or more peripheral connections/slots/ports configured to receive one or more peripheral devices, such as a secure digital (SD) slot configured for receiving a SD card, a mini SD slot configured to receive a mini SD card, a micro SD slot configured to receive a micro SD card, a universal serial bus (USB) port configured to receive a USB device, etc. In some cases, each one of the peripheral connections/slots/ports of the camera 104 is powered and polled irrespective of whether or not a peripheral device is connected thereon. Accordingly, even if there is no peripheral device connected to a peripheral connection/slot/port, power is still used to power and poll that peripheral connection/slot/port for information.

However, in some present aspects, the camera 104 determines whether or not each peripheral connection/slot/port is being used, that is, whether or not each peripheral connection/slot/port is connected to a peripheral device. If the camera 104 determines that a peripheral connection/slot/port is not connected to a peripheral device, the camera 104 puts that peripheral connection/slot/port into a low power state to be polled less frequently.

In an alternative aspect, if the camera 104 determines that a peripheral connection/slot/port is not connected to a peripheral device, the camera 104 may completely turn OFF that peripheral connection/slot/port.

In some alternative or additional aspects, one or more peripheral connections/slots/ports of the camera 104 may be put into the low power mode or may be completely turned OFF by a user via one or more user input receivers 114 on a power management dashboard 110 provided on the user interface 108 of the camera 104. Optionally, one or more power management indicators 112 on the power management dashboard 110 may be configured to inform the user as to whether or not one or more peripheral connections/slots/ports of the camera 104 are in use. The user may then use that information to put the unused peripheral connections/slots/ports into the low power mode or to completely turn OFF the unused peripheral connections/slots/ports via one or more user input receivers 114 on the power management dashboard 110.

### Smart Power Saving Camera Lens Defog

In some aspects, the camera 104 may include a defog heater configured for heating the interior of the camera 104 in order to clear condensation/fogging that may form on a lens of the camera 104. In some cases, the defog heater may require a lot of power to correct the temperature within the camera 104 in order to avoid or clear the condensation/fogging of the lens of the camera 104. In some cases, the heater is manually controllable by a user to operate either at 0% power or at 100% power (ON or OFF).

However, in some present aspects, the camera 104 may use video analytics processes to analyze the imagery captured through the lens of the camera 104 in order to detect the amount of fogging of the lens of the camera 104. In these aspects, the camera 104 may automatically switch the defog heater ON when the video analytics processes indicate that the lens is foggy, and may automatically switch the defog heater OFF when the video analytics processes indicate that the fogging has been sufficiently cleared.

In some aspects, for example, fuzzy logic may be used to choose which mode to put the defog heater into. In some non-limiting aspects, for example, a blur or sharpness algorithm may be used to determine when the fogging of the lens of the camera 104 has occurred and when the fogging of the lens of the camera 104 has been cleared. For example, if a sharpness algorithm indicates that the imagery captured through the lens of the camera 104 is not sharp enough (as compared to a threshold) and the colors are incorrect (as compared to a threshold), the camera 104 may determine that the lens is foggy, and may turn ON the defog heater. Subsequently, if the sharpness algorithm indicates that the imagery captured through the lens of the camera 104 is sharp enough (as compared to a threshold) and the colors are correct again (as compared to a threshold), the camera 104 may determine that the fogging of the lens of the camera 104 has been cleared, and may turn OFF the defog heater.

In some aspects, the power supplied to the defog heater may be controlled for optimization of the defogging of the lens of the camera 104 by prioritizing power conservation over the speed of defogging. In an aspect, for example, the camera 104 may determine the severity of the fogging of the lens of the camera 104 and the resulting degeneration of the images captured by the camera 104. The camera 104 may then implement power saving control, where the amount of power supplied to the defog heater is optimized to run at the minimum power necessary without impeding the quality of service for video surveillance.

In one non-limiting aspect, the power supplied to the defog heater may be selected from a set of distinct power levels, e.g., 0% (OFF), 20%, 50%, and 100% (fully ON).

In another non-limiting example aspect, the camera 104 may control the power supplied to the defog heater according to a curve determined beforehand to continuously control (e.g., gradually reduce) the power supplied to the defog heater in order to optimize the total power that is consumed for defogging the lens of the camera 104.

### Power Management Dashboard

Some present aspects provide a power management dashboard 110 via a user interface 108 on the camera 104. The power management dashboard 110 is configured to allow a user to monitor and control a power management component 106 of the camera 104 to achieve a desired power saving mode for the camera 104.

In an aspect, the power management dashboard 110 includes one or more power management indicators 112 that indicate a power management status of one or more features/components of the camera 104. The power management dashboard 110 further includes one or more user input receivers 114 that each is configured to receive a user input/selection for configuring the power management status of one or more features/components of the camera 104.

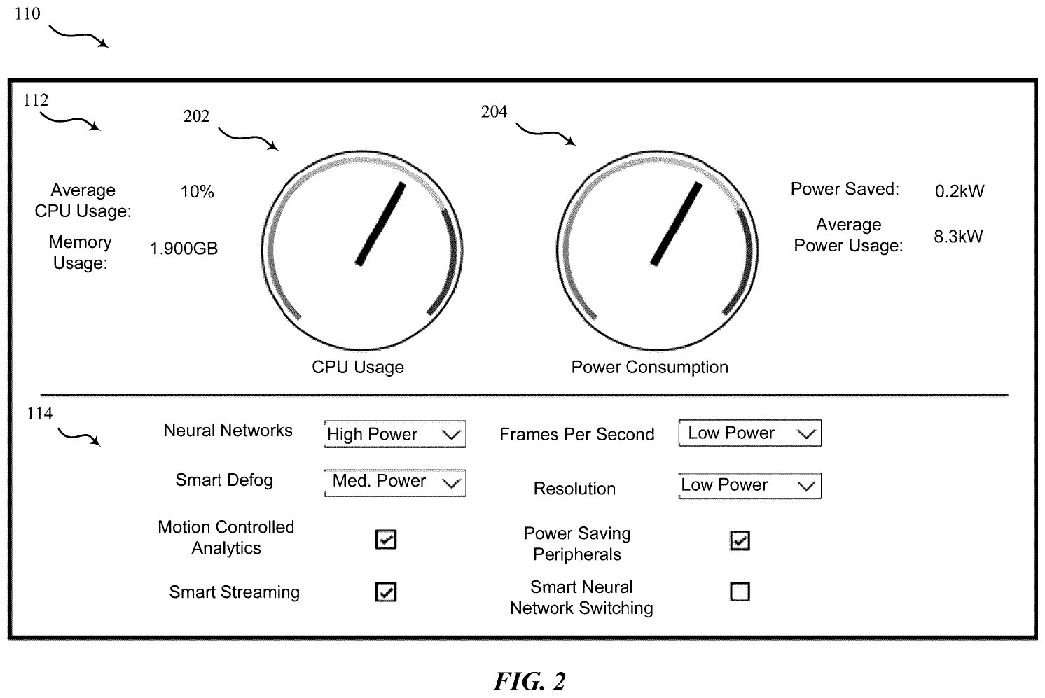

Referring to FIG. 2, in some aspects, the power management dashboard 110 on the camera 104 may include one or more power management indicators 112 configured for informing a user of the power management status of the camera 104. The power management dashboard 110 may also include various user input receivers 114 configured for allowing a user to adjust the power management status of the camera 104. In an aspect, for example, the power management dashboard 110 is configured to take readings of power consumption for different processes running on the camera 104, and the power saving modes of the camera 104 are mapped according to the CPU usage 202 and the power consumption 204 of the camera 104 to display real-time power management metrics and average measurements on the power management dashboard 110.

In an aspect, the user input receivers 114 provided on the power management dashboard 110 may allow a user to select a power saving mode for one or more of the aspects described above. For example, in one non-limiting aspect, the user input receivers 114 provided on the power management dashboard 110 may allow a user to select a high power mode, a medium power mode, or a low power mode for smart defogging of the camera 104 and/or for managing neural networks, FPS, and/or resolution associated with the video analytics processes running on the camera 104, as described above with reference to various aspects.

Further, in an aspect, the user input receivers 114 provided on the power management dashboard 110 may allow a user to select or unselect one or more power saving features for the camera 104, such as “Motion Controlled Analytics,” “Power Saving Peripherals,” “Smart Streaming,” “Smart Neural Network Switching,” etc., as described above with reference to various aspects.

In an aspect, the power saving modes of the camera 104 and the associated information are placed onto metadata that is communicated to external clients to avail them of such power saving information of the camera 104. In an aspect, for example, a metadata stream may continually stream the power saving information of the camera 104 to the building management station 102 that manages the peripherals (e.g., the cameras 104) in the video surveillance system 100. The building management station 102 may then monitor the power consumption of the camera 104 and make power saving or other recommendations based on the communicated information.

In some aspects, the power management dashboard 110 of the camera 104 may be displayed at the building management station 102 and may be configurable at the building management station 102. In an aspect, for example, the power management dashboard 110 of the camera 104 may be accessed via the building management station 102 to display power consumption statistics at the building management station 102. Accordingly, a user at the building management station 102 may control the power management dashboard 110 and/or the power management component 106 of the camera 104 from the building management station 102.

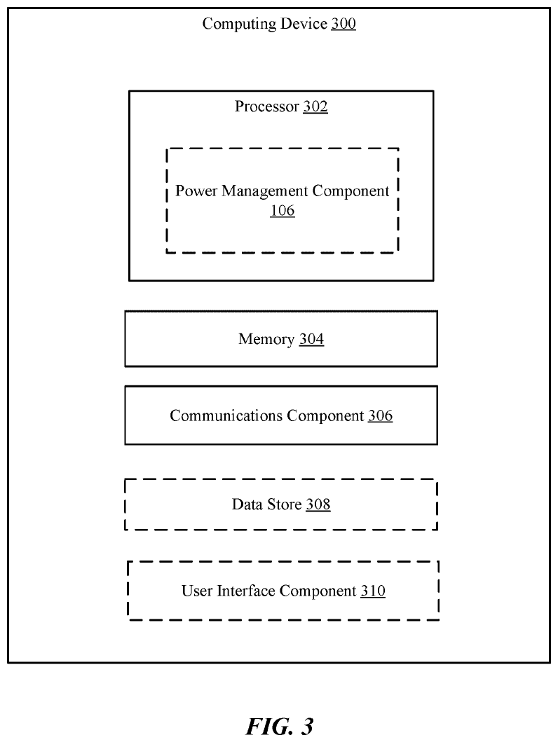

FIG. 3 illustrates an example block diagram providing details of computing components in a computing device 300 that may implement all or a portion of one or more components in a video surveillance system, a camera, a building management station, or any other device, system, or component described above. The computing device 300 includes a processor 302 which may be configured to execute or implement software, hardware, and/or firmware modules that perform any functionality described above with reference to one or more components in a video surveillance system, a camera, a building management station, or any other device, system, or component described above. For example, the processor 302 may be configured to execute a power management component 106 to provide power management functionality as described herein with reference to various aspects.

The processor 302 may be a micro-controller and/or may include a single or multiple set of processors or multi-core processors. Moreover, the processor 302 may be implemented as an integrated processing system and/or a distributed processing system. The computing device 300 may further include a memory 304, such as for storing local versions of applications being executed by the processor 302, related instructions, parameters, etc. The memory 304 may include a type of memory usable by a computer, such as random access memory (RAM), read only memory (ROM), tapes, flash drives, magnetic discs, optical discs, volatile memory, non-volatile memory, and any combination thereof. Additionally, the processor 302 and the memory 304 may include and execute an operating system executing on the processor 302, one or more applications, display drivers, etc., and/or other components of the computing device 300.

Further, the computing device 300 may include a communications component 306 that provides for establishing and maintaining communications with one or more other devices, parties, entities, etc., utilizing hardware, software, and services. The communications component 306 may carry communications between components on the computing device 300, as well as between the computing device 300 and external devices, such as devices located across a communications network and/or devices serially or locally connected to the computing device 300. For example, the communications component 306 may include one or more buses, and may further include transmit chain components and receive chain components associated with a wireless or wired transmitter and receiver, respectively, operable for interfacing with external devices.

Additionally, the computing device 300 may include a data store 308, which can be any suitable combination of hardware and/or software, that provides for mass storage of information, databases, and programs. For example, the data store 308 may be or may include a data repository for applications and/or related parameters not currently being executed by processor 302. In addition, the data store 308 may be a data repository for an operating system, application, display driver, etc., executing on the processor 302, and/or one or more other components of the computing device 300.

The computing device 300 may also include a user interface component 310 operable to receive inputs from a user of the computing device 300 and further operable to generate outputs for presentation to the user (e.g., via a display interface to a display device). The user interface component 310 may include one or more input devices, including but not limited to a keyboard, a number pad, a mouse, a touch-sensitive display, a navigation key, a function key, a microphone, a voice recognition component, or any other mechanism capable of receiving an input from a user, or any combination thereof. Further, the user interface component 310 may include one or more output devices, including but not limited to a display interface, a speaker, a haptic feedback mechanism, a printer, any other mechanism capable of presenting an output to a user, or any combination thereof.

Some further aspects are provided below.

1. A method comprising:
determining, by a camera, a power saving criteria associated with an amount of power consumed by the camera for performing image or video analytics;
selecting, by the camera, from among two or more neural networks configured for performing the image or video analytics under different power saving criteria, a neural network that is configured for performing the image or video analytics under the power saving criteria; and
using the neural network to perform the image or video analytics by the camera.

2. The method of clause 1, wherein determining the power saving criteria comprises selecting between a day-time operation and a night-time operation, wherein the two or more neural networks comprise:
a first neural network configured for performing the image or video analytics during the day-time operation; and
a second neural network configured for performing the image or video analytics during the night-time operation.

3. The method of clause 1 or 2, wherein the camera is configured to capture colored image or video during the day-time operation, wherein the camera is configured to capture black and white image or video during the night-time operation, wherein the first neural network has a greater number of nodes or edges as compared to the second neural network.

4. The method of any one of the above clauses, wherein the power saving criteria is associated with an amount of data captured by the camera under different environmental or scene complexity conditions.

5. The method of any one of the above clauses, wherein determining the power saving criteria comprises receiving a selection of a power saving mode via a user interface on the camera.

6. A method comprising:
determining, by a camera, whether image or video analytics performed at the camera has returned a detection result within a threshold period of time; and
placing, by the camera, the image or video analytics in a sleep mode responsive to an absence of any detection results returned by the image or video analytics.

7. The method of clause 6, further comprising:
determining, by the camera, subsequent to placing the image or video analytics in the sleep mode, whether a motion is detected in a vicinity of the camera; and
resuming, by the camera, the image or video analytics responsive to detection of the motion in the vicinity of the camera.

8. A method comprising:
receiving, by a camera, via a user interface on the camera, a power saving criteria associated with an amount of power consumed by the camera for performing image or video analytics; and
performing, by the camera, image or video analytics on image or video data having a frames per second “FPS” value or an image resolution value configured to meet the power saving criteria.

9. The method of clause 8, wherein receiving the power saving criteria comprises receiving the FPS value or the image resolution value via the user interface on the camera.

10. The method of clause 8 or 9, wherein receiving the power saving criteria comprises receiving, via the user interface, a confidence level associated with detection results of the image or video analytics, wherein performing the image or video analytics comprises performing the image or video analytics on the image or video data having the image resolution configured for reaching the confidence level.

11. The method of any one of clauses 8 to 10, wherein receiving the power saving criteria comprises receiving, via the user interface, a responsiveness level for the camera, wherein performing the image or video analytics comprises performing the image or video analytics on the image or video data having the FPS configured for providing the responsiveness level.

12. A method comprising:
determining, by a camera, whether all streams in a video pipeline of the camera are being used to stream video data output by the camera; and
closing, by the camera, one or more streams and one or more associated buffers responsive to determining that the one or more streams are not being used.

13. The method of clause 12, further comprising:
closing the video pipeline responsive to determining that no streams in the video pipeline are being used.

14. A method comprising:
determining, by a camera, whether a peripheral connection of the camera is connected to any peripheral devices; and
placing, by the camera, the peripheral connection in a low power state responsive to determining that the peripheral connection is not connected to any peripheral devices.

15. The method of clause 14, wherein placing the peripheral connection in the low power state comprises turning off the peripheral connection.

16. The method of clause 14 or 15, wherein placing the peripheral connection in the low power state comprises reducing a polling rate of the peripheral connection for data.

17. A method comprising:
determining, by a camera, whether a defogging of a lens of the camera is required; and
controlling, by the camera, a heater configured to defog the lens of the camera responsive to determining that the defogging of the lens of the camera is required.

18. The method of clause 17, wherein determining whether the defogging is required comprises analyzing a blurriness or a sharpness of images captured by the camera.

19. The method of clause 17 or 18, wherein controlling the heater comprises:
analyzing a blurriness or a sharpness of images captured by the camera; and
controlling a power supplied to the heater based on the blurriness or the sharpness of the images captured by the camera.

20. The method of any one of clauses 17 to 19, wherein controlling the heater comprises controlling a power supplied to the heater according to a stored power curve or table stored on the camera.

21. A method comprising:
displaying, by a camera, a power management dashboard on a user interface of the camera;
wherein the power management dashboard includes one or more power management indicators and one or more user input receivers;
wherein the one or more power management indicators include a central processing unit “CPU” usage indicator and a power consumption indicator configured, respectively, to display real-time measurements of a CPU usage and a power consumption of the camera; and
wherein the one or more user input receivers are configured for receiving user input for selecting a power saving mode for the camera.

22. The method of clause 21, further comprising streaming, to a building management device, power management information and metadata associated with the one or more power management indicators and the one or more user input receivers.

23. A computing device comprising:
a memory; and
a processor communicatively coupled with the memory and configured to perform the method of any one of clauses 1 to 22.

24. A non-transitory computer-readable medium storing instructions executable by a processor of a computing device, wherein the instructions, when executed, cause to the processor to perform the method of any one of clauses 1 to 22.

25. An apparatus comprising means for performing the method of any one of clauses 1 to 22.

Referring to FIGS. 3-8, in operation for power management, computing device 300 may implement at least a portion of one or more components in FIGS. 1-3 above, such as all or at least a portion of a camera 104 in FIG. 1, and may perform all or a portion of any one of methods 400, 500, 600, 700, and/or 800, or any combination of one or more of methods 400, 500, 600, 700, and/or 800, such as via execution of power management component 106 by processor 302 and/or memory 304. Specifically, computing device 300 may be configured to perform all or a portion of any one of methods 400, 500, 600, 700, and/or 800, or any combination of one or more of methods 400, 500, 600, 700, and/or 800, for performing one or more aspects of power management of a camera using one or more of: “Situational Switching Neural Networks,” “Motion Detection Management of Analytics,” “Reduced Frames-Per-Second (FPS) and Resolution Power Saving,” “Smart Video Streaming,” “Power Saving Peripherals Management,” “Smart Power Saving Camera Lens Defog,” and “Power Management Dashboard,” as described herein.

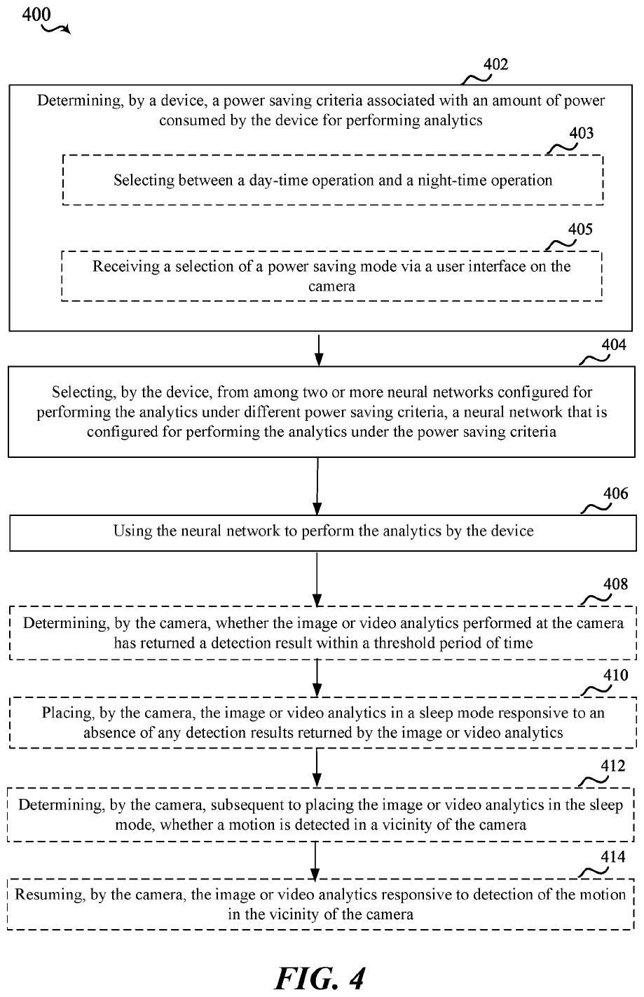

Referring to FIG. 4, at block 402 method 400 includes determining, by a device, a power saving criteria associated with an amount of power consumed by the device for performing analytics. For example, in an aspect, computing device 300, processor 302, memory 304, and/or power management component 106 may be configured to or may comprise means for determining, by a device, a power saving criteria associated with an amount of power consumed by the device for performing analytics.

In some optional implementations, the device may include a camera, and the analytics may include image or video analytics. For example, the camera 104 may execute the power management component 106 to determine a power saving criteria associated with an amount of power consumed by the camera 104 for performing image or video analytics on image or video data captured by the camera 104. In some aspects, for example, the power saving criteria may be determined based on a user selection received via a user input receiver 114 on a power management dashboard 110 provided by a user interface 108 on the camera 104.

At block 404 method 400 includes selecting, by the device, from among two or more neural networks configured for performing the analytics under different power saving criteria, a neural network that is configured for performing the analytics under the power saving criteria. For example, in an aspect, computing device 300, processor 302, memory 304, and/or power management component 106 may be configured to or may comprise means for selecting, by the device, from among two or more neural networks configured for performing the analytics under different power saving criteria, a neural network that is configured for performing the analytics under the power saving criteria.

For example, the camera 104 may further execute the power management component 106 to select one of a plurality of possible neural networks that each are configured for performing image or video analytics under different power saving criteria. For example, a first neural network having a number of nodes may be configured for performing image or video analytics under a first power saving criteria, while a second neural network having fewer number of nodes may be configured for performing image or video analytics under a second power saving criteria that is tighter (demands less power consumption) than the first power saving criteria.

In some optional implementations, the two or more neural networks may comprise a generative adversarial network “GAN” that comprises a generator neural network and a discriminator neural network. A GAN is a machine learning model in which two neural networks (a generator and a discriminator) compete with each other by using deep learning methods to become more accurate in their predictions.

In some optional implementations, the different power saving criteria may comprise a first power saving criteria and a second power saving criteria, wherein the second power saving criteria allows for consuming more power than the first power saving criteria.

In some optional implementations, selecting the neural network at block 404 may include selecting, responsive to the power saving criteria being the first power saving criteria, only the generator neural network, only the discriminator neural network, or a different neural network different than the generator neural network and the discriminator neural network, for performing the analytics; and selecting, responsive to the power saving criteria being the second power saving criteria, the GAN for performing the analytics.

For example, if the desired power saving criteria allows for enough power consumption to execute GAN, an edge device may use GAN for performing analytics. However, if the desired power saving criteria does not allow for enough power consumption to execute GAN, an edge device may bypass the entire GAN (e.g., may use a different neural network), or may use only one of the generator or discriminator neural networks of the GAN (assuming they are well trained) and bypass the other one of the generator or discriminator neural networks of the GAN.

At block 406 method 400 includes using the neural network to perform the analytics by the device. For example, in an aspect, computing device 300, processor 302, memory 304, and/or power management component 106 may be configured to or may comprise means for using the neural network to perform the analytics by the device.

For example, the camera 104 may execute the power management component 106 to perform image or video analytics using the neural network that was selected at block 404.

Optionally, in some implementations, determining the power saving criteria at block 402 may include block 403, and at block 403 method 400 may include selecting between a day-time operation and a night-time operation. In these implementations, the two or more neural networks may include a first neural network configured for performing the image or video analytics during the day-time operation; and a second neural network configured for performing the image or video analytics during the night-time operation. For example, in some optional implementations, the camera 104 may select a first neural network for performing image or video analytics during day-time operation, and may select a second neural network for performing image or video analytics during night-time operation

Optionally, in some implementations, the camera may be configured to capture colored image or video during the day-time operation, and the camera may be further configured to capture black and white image or video during the night-time operation. In these implementations, the first neural network may have a greater number of nodes or edges as compared to the second neural network.

Optionally, in some implementations, the power saving criteria may be associated with an amount of data captured by the camera under different environmental or scene complexity conditions.

Optionally, in some implementations, determining the power saving criteria at block 402 may include block 405, and at block 405 method 400 may include receiving a selection of a power saving mode via a user interface on the camera. For example, the camera 104 may determine the power saving criteria based on a power saving mode selected via a user input receiver 114 on a power management dashboard 110 provided by a user interface 108 on the camera 104.

In some optional implementations, at block 408 method 400 may further include determining, by the camera, whether the image or video analytics performed at the camera has returned a detection result within a threshold period of time. For example, in an aspect, computing device 300, processor 302, memory 304, and/or power management component 106 may be configured to or may comprise means for determining, by the camera, whether the image or video analytics performed at the camera has returned a detection result within a threshold period of time.

For example, the camera 104 may execute the power management component 106 to determine whether an event, object, etc. has been detected within a period of time by the image or video analytics performed at the camera 104.

In some optional implementations, at block 410 method 400 may further include placing, by the camera, the image or video analytics in a sleep mode responsive to an absence of any detection results returned by the image or video analytics. For example, in an aspect, computing device 300, processor 302, memory 304, and/or power management component 106 may be configured to or may comprise means for placing, by the camera, the image or video analytics in a sleep mode responsive to an absence of any detection results returned by the image or video analytics.

For example, the camera 104 may be placed in a sleep mode if no event, object, etc. has been detected by the image or video analytics performed at the camera 104 for a period of time (e.g., for a number of minutes such as 5 minutes).

In some optional implementations, at block 412 method 400 may further include determining, by the camera, subsequent to placing the image or video analytics in the sleep mode, whether a motion is detected in a vicinity of the camera. For example, in an aspect, computing device 300, processor 302, memory 304, and/or power management component 106 may be configured to or may comprise means for determining, by the camera, subsequent to placing the image or video analytics in the sleep mode, whether a motion is detected in a vicinity of the camera.

For example, after the camera 104 is placed in the low power mode, the camera 104 may determine whether motion is detected, for example, by running an external process and using a motion detection sensor in the camera 104.

In some optional implementations, at block 414 method 400 may further include resuming, by the camera, the image or video analytics responsive to detection of the motion in the vicinity of the camera. For example, in an aspect, computing device 300, processor 302, memory 304, and/or power management component 106 may be configured to or may comprise means for resuming, by the camera, the image or video analytics responsive to detection of the motion in the vicinity of the camera.

For example, if the camera 104 detects motion while in the low power mode, the camera 104 returns to a higher power/normal mode and resumes performing the image or video analytics.

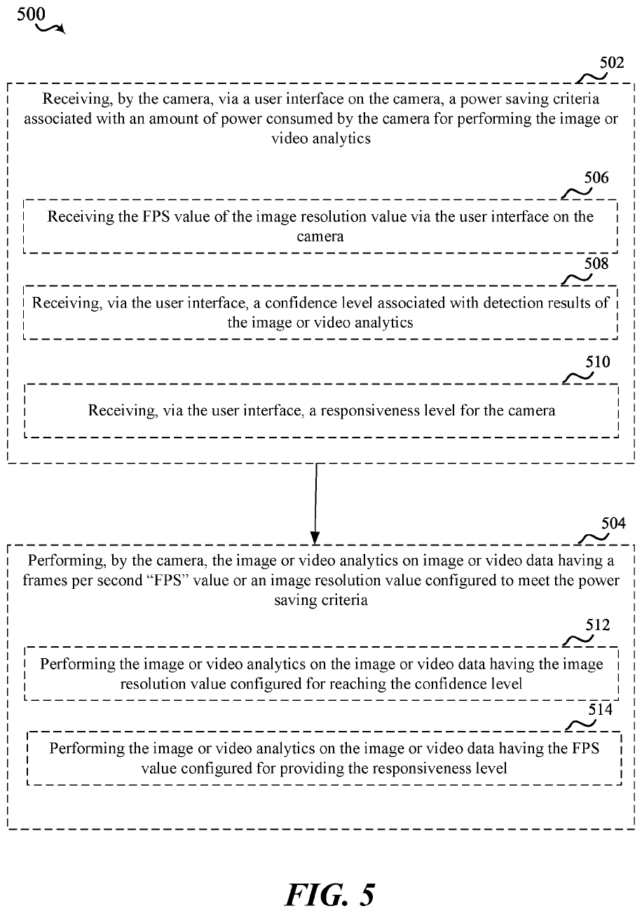

Referring to FIG. 5, in some alternative or additional optional implementations, at block 502 method 500 may include receiving, by the camera, via a user interface on the camera, a power saving criteria associated with an amount of power consumed by the camera for performing the image or video analytics. For example, in an aspect, computing device 300, processor 302, memory 304, and/or power management component 106 may be configured to or may comprise means for receiving, by the camera, via a user interface on the camera, a power saving criteria associated with an amount of power consumed by the camera for performing the image or video analytics.

For example, a user may use the user input receivers 114 on the user interface 108 of the camera 104 to provide a power saving criteria related to, for example, a neural network used for performing image or video analytics at the camera 104, such as an FPS, resolution, etc.

In some optional implementations, at block 504 method 500 may further include performing, by the camera, the image or video analytics on image or video data having a frames per second “FPS” value or an image resolution value configured to meet the power saving criteria. For example, in an aspect, computing device 300, processor 302, memory 304, and/or power management component 106 may be configured to or may comprise means for performing, by the camera, the image or video analytics on image or video data having an FPS value or an image resolution value configured to meet the power saving criteria.

For example, the camera 104 may use an FPS value and/or a resolution value for image or video on which image or video analytics is performed, and may select the FPS/resolution value in such a way as to meet the power saving criteria. For example, a lower FPS/resolution may be selected for a more restrict power saving criteria (for saving more power) as compared to a more relaxed power saving criteria (when more power can be used).

In some optional implementations, block 502 may further include block 506, and at block 506 method 500 may further include receiving the FPS value or the image resolution value via the user interface on the camera. For example, in an aspect, computing device 300, processor 302, memory 304, and/or power management component 106 may be configured to or may comprise means for receiving the FPS value or the image resolution value via the user interface on the camera.

For example, the power saving criteria received by the camera 104 may be the FPS value or the image resolution value received via the user interface 108 on the camera 104.

In some optional implementations, block 502 may further include block 508, and at block 508 method 500 may further include receiving, via the user interface, a confidence level associated with detection results of the image or video analytics. For example, in an aspect, computing device 300, processor 302, memory 304, and/or power management component 106 may be configured to or may comprise means for receiving, via the user interface, a confidence level associated with detection results of the image or video analytics.

For example, a user may use the user interface 108 of the camera 104 to enter a confidence level associated with detection results (e.g., event or object/person detection results) of the image or video analytics performed by the camera 104.

In some optional implementations, block 502 may further include block 510, and at block 510 method 500 may further include receiving, via the user interface, a responsiveness level for the camera. For example, in an aspect, computing device 300, processor 302, memory 304, and/or power management component 106 may be configured to or may comprise means for receiving, via the user interface, a responsiveness level for the camera.

For example, a user may use the user interface 108 of the camera 104 to enter a responsiveness for the camera 104. In some aspects, the responsiveness is a measure of how fast the camera responds for detecting, for example, an object or event in image or video captured by the camera 104.

In some optional implementations, block 504 may further include block 512, and at block 512 method 500 may further include performing the image or video analytics on the image or video data having the image resolution value configured for reaching the confidence level. For example, in an aspect, computing device 300, processor 302, memory 304, and/or power management component 106 may be configured to or may comprise means for performing the image or video analytics on the image or video data having the image resolution value configured for reaching the confidence level.

For example, in response to receiving a desired confidence level via the user interface 108, the camera 104 may perform image or video analytics on image or video data having an image resolution value that is configured for reaching the desired confidence level.

In some optional implementations, block 504 may further include block 514, and at block 514 method 500 may further include performing the image or video analytics on the image or video data having the FPS value configured for providing the responsiveness level. For example, in an aspect, computing device 300, processor 302, memory 304, and/or power management component 106 may be configured to or may comprise means for performing the image or video analytics on the image or video data having the FPS value configured for providing the responsiveness level.

For example, in response to receiving a desired responsiveness level via the user interface 108, the camera 104 may perform image or video analytics on image or video data having an FPS value that is configured for reaching the desired responsiveness level.

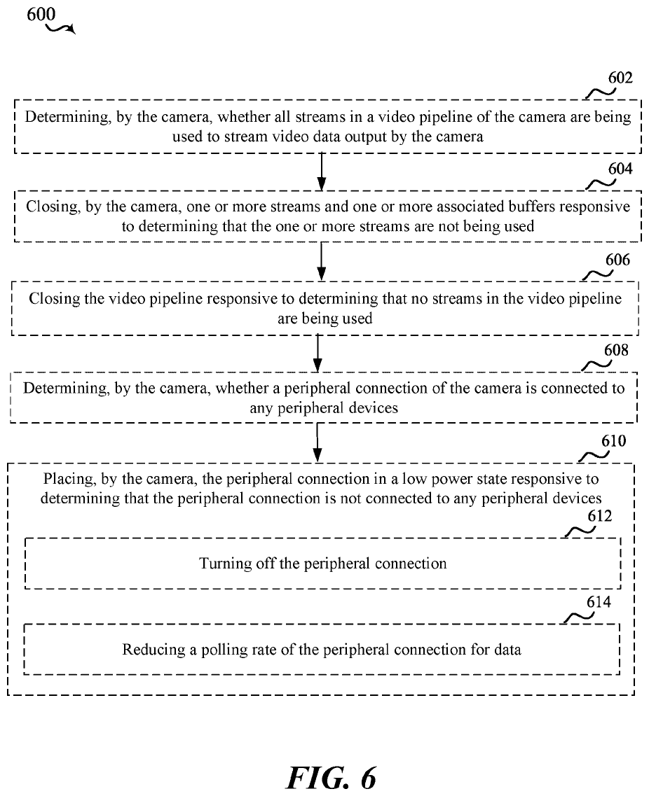

Referring to FIG. 6, in some alternative additional or optional implementations, at block 602 method 600 may further include determining, by the camera, whether all streams in a video pipeline of the camera are being used to stream video data output by the camera. For example, in an aspect, computing device 300, processor 302, memory 304, and/or power management component 106 may be configured to or may comprise means for determining, by the camera, whether all streams in a video pipeline of the camera are being used to stream video data output by the camera.

For example, the camera 104 may execute the power management component 106 to determine whether all streams in a video pipeline of the camera 104 are being used to stream video data output by the camera 104.

In some optional implementations, at block 604 method 600 may further include closing, by the camera, one or more streams and one or more associated buffers responsive to determining that the one or more streams are not being used. For example, in an aspect, computing device 300, processor 302, memory 304, and/or power management component 106 may be configured to or may comprise means for closing, by the camera, one or more streams and one or more associated buffers responsive to determining that the one or more streams are not being used.

For example, if a stream is not being used to stream video data that is output by the camera 104, the camera 104 may close that stream and any associated buffers.

In some optional implementations, at block 606 method 600 may further include closing the video pipeline responsive to determining that no streams in the video pipeline are being used. For example, in an aspect, computing device 300, processor 302, memory 304, and/or power management component 106 may be configured to or may comprise means for closing the video pipeline responsive to determining that no streams in the video pipeline are being used.

For example, if no streams in the video pipeline of the camera 104 are being used to stream video data that is output by the camera 104 (e.g., if there is no client or destination streaming imaging from the camera 104), the camera 104 may close the entire video pipeline.

In some optional implementations, at block 608 method 600 may further include determining, by the camera, whether a peripheral connection of the camera is connected to any peripheral devices. For example, in an aspect, computing device 300, processor 302, memory 304, and/or power management component 106 may be configured to or may comprise means for determining, by the camera, whether a peripheral connection of the camera is connected to any peripheral devices.

For example, the camera 104 may determine whether a peripheral connection of the camera 104 is connected to any peripheral devices, where the peripherals may include any connections/slots/ports configured to receive one or more peripheral devices, such as a SD slot configured for receiving a SD card, a mini SD slot configured to receive a mini SD card, a micro SD slot configured to receive a micro SD card, a USB port configured to receive a USB device, etc.

In some optional implementations, at block 610 method 600 may further include placing, by the camera, the peripheral connection in a low power state responsive to determining that the peripheral connection is not connected to any peripheral devices. For example, in an aspect, computing device 300, processor 302, memory 304, and/or power management component 106 may be configured to or may comprise means for placing, by the camera, the peripheral connection in a low power state responsive to determining that the peripheral connection is not connected to any peripheral devices.

For example, if a connection/slot/port is not connected to a peripheral device, the camera 104 may place that connection/slot/port in a low power state.

In some optional implementations, block 610 may further include block 612, and at block 612 method 600 may further include placing the peripheral connection in the low power state comprises turning off the peripheral connection. For example, in an aspect, computing device 300, processor 302, memory 304, and/or power management component 106 may be configured to or may comprise means for placing the peripheral connection in the low power state comprises turning off the peripheral connection.

For example, if a connection/slot/port is not connected to a peripheral device, the camera 104 may turn off that connection/slot/port.

In some optional implementations, block 610 may further include block 614, and at block 614 method 600 may further include reducing a polling rate of the peripheral connection for data. For example, in an aspect, computing device 300, processor 302, memory 304, and/or power management component 106 may be configured to or may comprise means for reducing a polling rate of the peripheral connection for data.

For example, if a connection/slot/port is not connected to a peripheral device, the camera 104 may reducing a polling rate of that connection/slot/port.

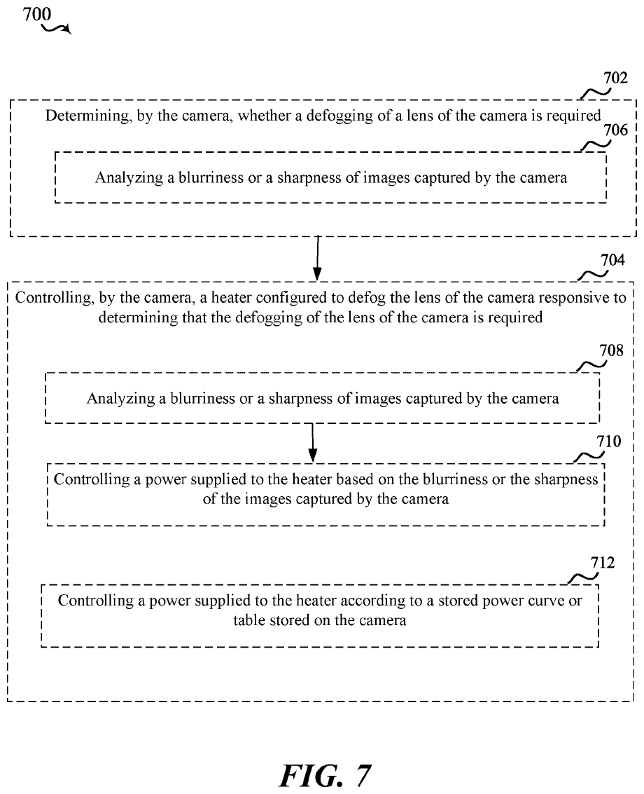

Referring to FIG. 7, in some alternative or additional optional implementations, at block 702 method 700 may include determining, by the camera, whether a defogging of a lens of the camera is required. For example, in an aspect, computing device 300, processor 302, memory 304, and/or power management component 106 may be configured to or may comprise means for determining, by the camera, whether a defogging of a lens of the camera is required.

For example, the camera 104 may use, for example, image or video captured through a lens of the camera 104 to determine whether a defogging of the lens of the camera 104 is required.

In some optional implementations, at block 704 method 700 may further include controlling, by the camera, a heater configured to defog the lens of the camera responsive to determining that the defogging of the lens of the camera is required. For example, in an aspect, computing device 300, processor 302, memory 304, and/or power management component 106 may be configured to or may comprise means for controlling, by the camera, a heater configured to defog the lens of the camera responsive to determining that the defogging of the lens of the camera is required.

For example, if a lens of the camera 104 requires defogging, the camera 104 may control the operation of a heater that is configured to defog the lens of the camera 104.

In some optional implementations, block 702 may further include block 706, and at block 706 method 700 may further include analyzing a blurriness or a sharpness of images captured by the camera. For example, in an aspect, computing device 300, processor 302, memory 304, and/or power management component 106 may be configured to or may comprise means for analyzing a blurriness or a sharpness of images captured by the camera.

For example, the camera 104 may analyze a blurriness or a sharpness of images captured by the camera 104 through a lens to determine whether the lens requires defogging.

In some optional implementations, block 704 may further include block 708, and at block 708 method 700 may further include analyzing a blurriness or a sharpness of images captured by the camera. For example, in an aspect, computing device 300, processor 302, memory 304, and/or power management component 106 may be configured to or may comprise means for analyzing a blurriness or a sharpness of images captured by the camera.

For example, the camera 104 may control the defogging heater of a lens based on blurriness or sharpness of images captured by the camera 104 through that lens.

In some optional implementations, block 704 may further include block 710, and at block 710 method 700 may further include controlling a power supplied to the heater based on the blurriness or the sharpness of the images captured by the camera. For example, in an aspect, computing device 300, processor 302, memory 304, and/or power management component 106 may be configured to or may comprise means for controlling a power supplied to the heater based on the blurriness or the sharpness of the images captured by the camera.

For example, the camera 104 may control the power supplied to the defogging heater of a lens based on blurriness or sharpness of images captured by the camera 104 through that lens.

In some optional implementations, block 704 may further include block 712, and at block 712 method 700 may further include controlling a power supplied to the heater according to a stored power curve or table stored on the camera. For example, in an aspect, computing device 300, processor 302, memory 304, and/or power management component 106 may be configured to or may comprise means for controlling a power supplied to the heater according to a stored power curve or table stored on the camera.

For example, the camera 104 may use a stored power curve or table that is stored on the camera 104 to control the power supplied to the defogging heater to defog a lens of the camera 104.

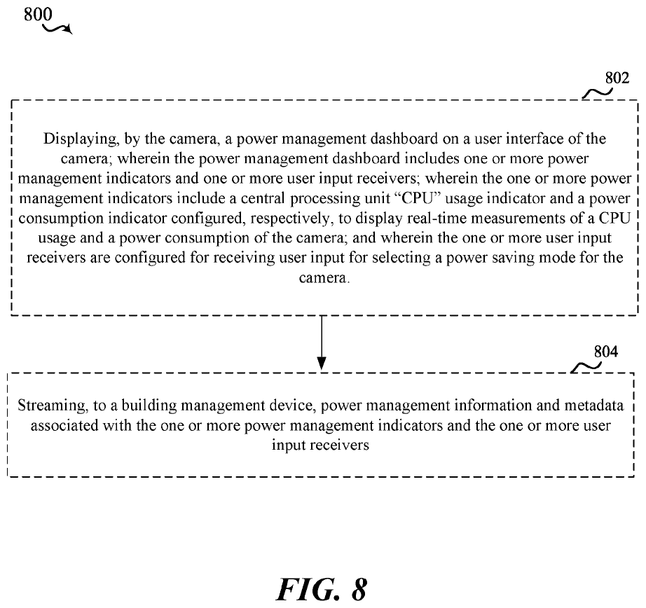

Referring to FIG. 8, in some alternative or additional optional implementations, at block 802 method 800 may include displaying, by the camera, a power management dashboard on a user interface of the camera; wherein the power management dashboard includes one or more power management indicators and one or more user input receivers; wherein the one or more power management indicators include a central processing unit “CPU” usage indicator and a power consumption indicator configured, respectively, to display real-time measurements of a CPU usage and a power consumption of the camera; and wherein the one or more user input receivers are configured for receiving user input for selecting a power saving mode for the camera. For example, in an aspect, computing device 300, processor 302, memory 304, and/or power management component 106 may be configured to or may comprise means for displaying, by the camera, a power management dashboard on a user interface of the camera; wherein the power management dashboard includes one or more power management indicators and one or more user input receivers; wherein the one or more power management indicators include a central processing unit “CPU” usage indicator and a power consumption indicator configured, respectively, to display real-time measurements of a CPU usage and a power consumption of the camera; and wherein the one or more user input receivers are configured for receiving user input for selecting a power saving mode for the camera.

For example, the camera 104 may include the user interface 108 providing a power management dashboard 110 that includes one or more power management indicators 112 and one or more user input receivers 114. The power management indicators 112 may include one or more indicators configured to indicate real-time measurements of CPU usage 202 and/or power consumption 204 of the camera 104. The user input receivers 114 may be configured for receiving user input for selecting a power saving mode for the camera 104, such as a high power mode, a medium power mode, a low power mode, etc.

In some optional implementations, at block 804 method 800 may further include streaming, to a building management device, power management information and metadata associated with the one or more power management indicators and the one or more user input receivers. For example, in an aspect, computing device 300, processor 302, memory 304, and/or power management component 106 may be configured to or may comprise means for streaming, to a building management device, power management information and metadata associated with the one or more power management indicators and the one or more user input receivers.

For example, power management information and metadata associated with the power management indicators 112 and the user input receivers 114 may be streamed by the camera 104 to a building management device.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method comprising:
determining, by a device, a power saving criteria associated with an amount of power consumed by the device for performing analytics;
selecting, by the device, from among two or more neural networks configured for performing the analytics under different power saving criteria, a neural network that is configured for performing the analytics under the power saving criteria; and
using the neural network to perform the analytics by the device.

2. The method of claim 1, wherein the device comprises a camera, wherein the analytics comprises image or video analytics.

3. The method of claim 2, wherein determining the power saving criteria comprises selecting between a day-time operation and a night-time operation, wherein the two or more neural networks comprise:
a first neural network configured for performing the image or video analytics during the day-time operation; and
a second neural network configured for performing the image or video analytics during the night-time operation.

4. The method of claim 3, wherein the camera is configured to capture colored image or video during the day-time operation, wherein the camera is configured to capture black and white image or video during the night-time operation, wherein the first neural network has a greater number of nodes or edges as compared to the second neural network.

5. The method of claim 2, wherein the power saving criteria is associated with an amount of data captured by the camera under different environmental or scene complexity conditions.

6. The method of claim 2, wherein determining the power saving criteria comprises receiving a selection of a power saving mode via a user interface on the camera.

7. The method of claim 2, further comprising:
determining, by the camera, whether the image or video analytics performed at the camera has returned a detection result within a threshold period of time; and
placing, by the camera, the image or video analytics in a sleep mode responsive to an absence of any detection results returned by the image or video analytics.

8. The method of claim 7, further comprising:
determining, by the camera, subsequent to placing the image or video analytics in the sleep mode, whether a motion is detected in a vicinity of the camera; and
resuming, by the camera, the image or video analytics responsive to detection of the motion in the vicinity of the camera.

9. The method of claim 2, further comprising:
receiving, by the camera, via a user interface on the camera, a power saving criteria associated with an amount of power consumed by the camera for performing the image or video analytics; and
performing, by the camera, the image or video analytics on image or video data having a frames per second “FPS” value or an image resolution value configured to meet the power saving criteria.

10. The method of claim 9, wherein receiving the power saving criteria comprises receiving the FPS value or the image resolution value via the user interface on the camera.

11. The method of claim 9, wherein receiving the power saving criteria comprises receiving, via the user interface, a confidence level associated with detection results of the image or video analytics, wherein performing the image or video analytics comprises performing the image or video analytics on the image or video data having the image resolution value configured for reaching the confidence level.

12. The method of claim 9, wherein receiving the power saving criteria comprises receiving, via the user interface, a responsiveness level for the camera, wherein performing the image or video analytics comprises performing the image or video analytics on the image or video data having the FPS value configured for providing the responsiveness level.

13. The method of claim 2, further comprising:
determining, by the camera, whether all streams in a video pipeline of the camera are being used to stream video data output by the camera; and
closing, by the camera, one or more streams and one or more associated buffers responsive to determining that the one or more streams are not being used.

14. The method of claim 13, further comprising:
closing the video pipeline responsive to determining that no streams in the video pipeline are being used.

15. The method of claim 2, further comprising:
determining, by the camera, whether a peripheral connection of the camera is connected to any peripheral devices; and
placing, by the camera, the peripheral connection in a low power state responsive to determining that the peripheral connection is not connected to any peripheral devices.

16. The method of claim 15, wherein placing the peripheral connection in the low power state comprises turning off the peripheral connection.

17. The method of claim 15, wherein placing the peripheral connection in the low power state comprises reducing a polling rate of the peripheral connection for data.

18. The method of claim 2, further comprising:
determining, by the camera, whether a defogging of a lens of the camera is required; and
controlling, by the camera, a heater configured to defog the lens of the camera responsive to determining that the defogging of the lens of the camera is required.

19. The method of claim 18, wherein determining whether the defogging is required comprises analyzing a blurriness or a sharpness of images captured by the camera.

20. The method of claim 18, wherein controlling the heater comprises:
analyzing a blurriness or a sharpness of images captured by the camera; and
controlling a power supplied to the heater based on the blurriness or the sharpness of the images captured by the camera.

21. The method of claim 18, wherein controlling the heater comprises controlling a power supplied to the heater according to a stored power curve or table stored on the camera.

22. The method of claim 2, further comprising:
displaying, by the camera, a power management dashboard on a user interface of the camera;
wherein the power management dashboard includes one or more power management indicators and one or more user input receivers;
wherein the one or more power management indicators include a central processing unit “CPU” usage indicator and a power consumption indicator configured, respectively, to display real-time measurements of a CPU usage and a power consumption of the camera; and
wherein the one or more user input receivers are configured for receiving user input for selecting a power saving mode for the camera.

23. The method of claim 22, further comprising streaming, to a building management device, power management information and metadata associated with the one or more power management indicators and the one or more user input receivers.

24. The method of claim 1, wherein the two or more neural networks comprise a generative adversarial network “GAN” that comprises a generator neural network and a discriminator neural network.

25. The method of claim 24, wherein the different power saving criteria comprises a first power saving criteria and a second power saving criteria, wherein the second power saving criteria allows for consuming more power than the first power saving criteria, wherein selecting the neural network comprises:
selecting, responsive to the power saving criteria being the first power saving criteria, only the generator neural network, only the discriminator neural network, or a different neural network different than the generator neural network and the discriminator neural network, for performing the analytics; and
selecting, responsive to the power saving criteria being the second power saving criteria, the GAN for performing the analytics.

26. A computing device comprising:
a memory storing instructions; and
a processor communicatively coupled with the memory and configured to execute the instructions to:
determine, by a device, a power saving criteria associated with an amount of power consumed by the device for performing analytics;
select, by the device, from among two or more neural networks configured for performing the analytics under different power saving criteria, a neural network that is configured for performing the analytics under the power saving criteria; and
use the neural network to perform the analytics by the device.

27. A non-transitory computer-readable medium storing instructions executable by a processor of a computing device, wherein the instructions, when executed, cause to the processor to:
determine, by a device, a power saving criteria associated with an amount of power consumed by the device for performing analytics;
select, by the device, from among two or more neural networks configured for performing the analytics under different power saving criteria, a neural network that is configured for performing the analytics under the power saving criteria; and
use the neural network to perform the analytics by the device.
